(19) United States
(12) Patent Application Publication
(10) Pub. No.: US 2020/0220673 A1
(43) Pub. Date: Jul. 9, 2020

(54) FRAME STRUCTURE FOR UNLICENSED NARROWBAND INTERNET-OF-THINGS SYSTEM

(71) Applicant: APPLE INC., Cupertino, CA (US)

(72) Inventors: Wenting CHANG, Beijing (CN); Huaning NIU, San Jose, CA (US); Qiaoyang YE, Fremont, CA (US); Salvatore TALARICO, Sunnyvale, CA (US)

(73) Assignee: Apple Inc., Cupertino, CA (US)

(21) Appl. No.: 16/638,028

(22) PCT Filed: Aug. 10, 2018
(86) PCT No.: PCT/US2018/046250

§ 371 Date: Feb. 10, 2020

(30) Foreign Application Priority Data
Aug. 11, 2017 (CN) PCT/CN17/97039

(51) Int. Cl. H04L 5/00; H04L 5/14; H04W 4/70; H04W 16/14

(52) U.S. Cl. CPC H04L 5/0012; H04L 5/0048; H04W 16/14; H04W 4/70; H04L 5/1469

(57) ABSTRACT

The disclosure describes frame structure with downlink/uplink subframe configuration and channel hopping scheme for unlicensed narrowband Internet-of-Things (IoT) systems. An apparatus operable for unlicensed narrowband transmission to support IoT service is disclosed. The apparatus includes baseband circuitry to select a transmission channel within an unlicensed narrow band for downlink transmission of a discovery reference signal (DRS), and for channel hopping, to select, according to the DRS, a communication channel within the unlicensed narrow band for downlink data and uplink data. The DRS includes a primary synchronization signal (PSS), a secondary synchronization signal (SSS) and physical broadcast channel (PBCH) content. The baseband circuitry is further to demodulate a received signal received via radio frequency (RF) circuitry through the communication channel over an uplink frame, and to modulate a transmitting signal to be transmitted via the RF circuitry through the communication channel over a downlink frame.

### CROSS REFERENCE TO RELATED APPLICATION

This application claims priority to PCT International Application No. PCT/CN2017/097039 filed Aug. 11, 2017. The specification of said application is hereby incorporated by reference in its entirety.

### TECHNICAL FIELD

This disclosure is related generally to frame structure for an unlicensed narrowband Internet-of-Things (IoT) system, and more specifically to frame structure with downlink/uplink subframe configuration and channel hopping scheme for the unlicensed narrowband IoT system.

### BACKGROUND ART

For Internet-of-Things (IoT) service, narrowband IoT (NB-IoT) is a Low Power Wide Area Network (LPWAN) radio technology standard to provide for a wide range of cellular devices and services. Generally, the agreed maximum coupling loss (MCL) for enhanced

Machine-Type Communication (eMTC) in an unlicensed narrow band is 130 dB. However, in the LTE (Long Term Evolution) system, the MCL of NB-IoT is 8 dB better than the MCL of eMTC. That is to say, the MCL of the NB-IoT in the unlicensed narrow band can reach 138 dB. In some cases, the MCL of the NB-IoT in the unlicensed narrow band can be enhanced (for example, by repeating transmission) to 144 dB, which is comparable to the non-coverage-enhanced MCL of the NB-IoT in licensed narrow band (i.e., MCL of the NB-IoT in licensed narrow band without coverage enhancement). Accordingly, the MCL of NB-IoT in the unlicensed narrow band can range from 138 dB to 144 dB. Currently, for different territories or regions (e.g., Europe, the United States, etc.), the regulation for NB-IoT in the unlicensed narrow band is different.

### BRIEF DESCRIPTION OF THE DRAWINGS

Other features and advantages of the disclosure will become apparent in the following detailed description of the embodiments with reference to the accompanying drawings, of which:

FIG. 1 illustrates an exemplary operating environment of an unlicensed NB-IoT system according to some embodiments of this disclosure;

FIG. 2 illustrates an example of unified frame structure with four anchor channels according to some embodiments of this disclosure;

FIG. 3 illustrates an example of a frame having subframes for starting the discovery reference signals (DRS's) without collision;

FIG. 4 illustrates another example of a frame having subframes for starting the DRS's with collision;

FIG. 5 illustrates an example of non-unified frame structure without anchor channel according to some embodiments of this disclosure;

FIG. 6 illustrates another example of non-unified frame structure without anchor channel according to some embodiments of this disclosure;

FIG. 7 is a flowchart of a method for unlicensed narrowband transmission to support Internet-of-Things service according to some embodiments of this disclosure;

FIG. 8 is a schematic block diagram illustrating an apparatus for unlicensed narrowband transmission according to some embodiments of this disclosure;

FIG. 9 illustrates example interfaces of baseband circuitry according to some embodiments of this disclosure;

FIG. 10 illustrates an architecture of a system of a network according to some embodiments of this disclosure;

FIG. 11 illustrates another architecture of a system of a network according to some embodiments of this disclosure;

FIG. 12 illustrates an example of a control plane protocol stack according to some embodiments of this disclosure; and

FIG. 13 illustrates an example of a user plane protocol stack according to some embodiments of this disclosure.

### DESCRIPTION OF THE EMBODIMENTS

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology used herein is for the purpose of describing particular examples only and is not intended to be limiting.

The following description and the accompanying drawings provide specific embodiments to enable those skilled in the art to embody the concept of this disclosure. A number of examples are described with reference to 3GPP (Third Generation Partnership Project) communication systems. It will be understood that principles of the embodiments may be applicable in other types of communication systems, such as Wi-Fi or Wi-Max networks, Bluetooth® or other personal-area networks, Zigbee or other home-area networks, and the like, without limitation, unless specifically stated in this disclosure.

Narrowband IoT (NB-IoT) systems have been developed by 3GPP to provide for a wide range of cellular devices and services. NB-IoT systems focus specifically on indoor coverage, low cost, long battery life, and high connection density. NB-IoT systems use a subset of the LTE (Long Term Evolution) standard, but limits the bandwidth to a single narrow band of 200 kHz. Further, deployment of NB-IOT in unlicensed bands is desirable as a way to provide more spectrum at a low cost. Various embodiments of frame structure with downlink/uplink subframe configuration and channel hopping scheme for an unlicensed NB-IoT system are described in the following with reference to the accompanying drawings.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

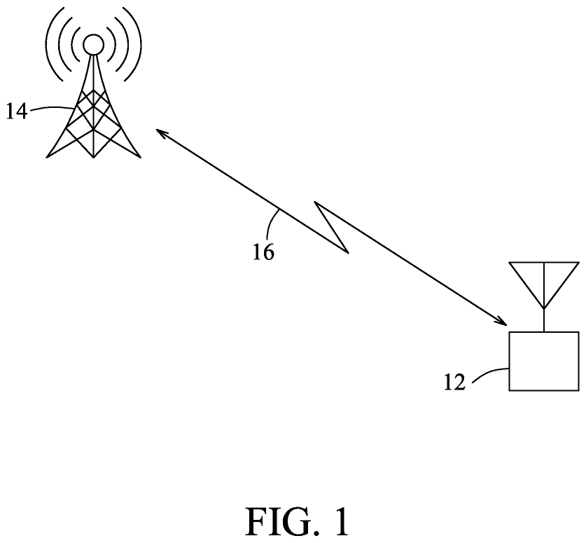

FIG. 1 illustrates an exemplary operating environment of an unlicensed NB-IoT system 10 that includes a user equipment (UE) 12 (e.g., an IoT device) and a radio access network (RAN) node 14 (e.g., a cellular base station). The UE 12 can communicate with the RAN node 14 over a wireless connection 16 in an unlicensed narrow band. The wireless connection 16 is compatible with NB-IoT in unlicensed narrow band. The UE 12 and the RAN node 14 can implement uplink transmission and downlink transmission therebetween in the unlicensed narrow band with the frame structure described herein.

In some embodiments, the RAN node 14 may include a baseband circuitry and a radio frequency (RF) circuitry. The baseband circuitry may include one or more processors to handle various radio control functions that enable communication with one or more radio networks via the RF circuitry. The radio control functions may include, but are not limited to, signal modulation/demodulation, encoding/decoding, radio frequency shifting, etc. The RF circuitry is configured to enable communication through the wireless connection 16 using modulated electromagnetic radiation. In various embodiments, the RF circuitry may include switches, filters, amplifiers, etc., to facilitate the communication through the wireless connection 16.

Unified Frame Structure

In some embodiments, unified frame structure can be applied to all regions. In the unified frame structure, at least one anchor channel is selected and predetermined as a transmission channel within the unlicensed narrow band for downlink transmission of a discovery reference signal (DRS). In some embodiments, the DRS includes a primary synchronization signal (PSS), a secondary synchronization signal (SSS) and physical broadcast channel (PBCH) content.

In some embodiments, the processors of the baseband circuitry predetermine the anchor channel according to a cell identifier (cell ID) associated with the RAN node 14. In other embodiments, a channel within the unlicensed narrow band having the smallest or largest index is pre-defined as the anchor channel.

In some embodiments, the processors of the baseband circuitry predetermine a number of the at least one anchor channel, where the number of the at least one anchor channel depends on a region where the RAN node 14 is to be set up.

For example, in Europe, if only four channels (e.g., four 200 KHz channels) in the unlicensed narrow band of 865 MHz to 868 MHz are available, the number of the anchor channels can be four. In some embodiments, the four anchor channels can be used, for example, by the RF circuitry, as a physical downlink shared channel (PDSCH) and a physical uplink shared channel (PUSCH) for data transmission. When additional channels are approved in the future by corresponding regulation within other frequency bands (e.g., 917.3-917.7 MHz, 918.5-918.9 MHz, and 919.7-920.1 MHz), the anchor channels can remain unchanged while only data channel(s) is expanded.

In the United States, there is only one anchor channel while a total number of data channels available for channel hopping can be more than 25. In one embodiment, if only one anchor channel is available, the anchor channel might not be needed to boost spectral efficiency. When other channels are added in the future, one or more anchor channels could be defined in newly available frequency bands.

In other embodiments, the number of the at least one anchor channel may be identical for all regions. For example, there is only one anchor channel in the United States, and only one channel of the four channels in the unlicensed narrow band is predefined as the anchor channel in Europe.

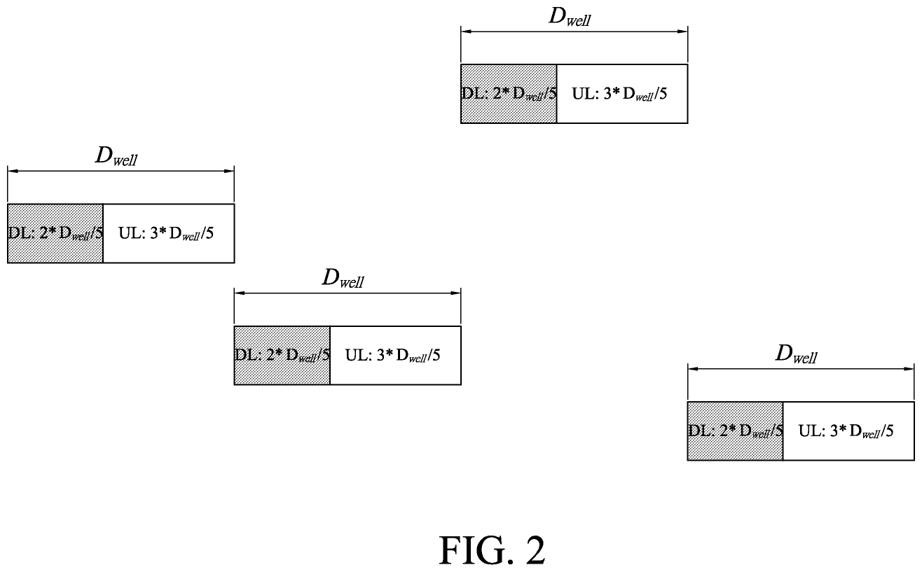

In one option of the unified frame structure, for example in Europe, the RF circuitry is configured to use each anchor channel as the transmission channel for the downlink transmission of the DRS, and to also use each anchor channel as a communication channel (data channel) for downlink data and uplink data. In each channel, a frame during an observation time (dwell time) may include a string of downlink subframes concatenating with a string of uplink subframes. The dwell time of a frame, during which the communication channel is to transmit and receive data, may be determined based on medium-utilization limitation. The processors of the baseband circuitry of the RAN node 14 divide a frame in each anchor channel into consecutive downlink subframes and consecutive uplink subframes while a number of the consecutive downlink subframes is limited to satisfying

$$\frac{{T}_{D L}}{{N}_{a n c h o r} {D}_{w e l l}} = 10 \%$$

where T_{DL} indicates a time duration of the consecutive downlink subframes, N_{anchor} indicates the number of the anchor channels, and D_{well} indicates the dwell time. On the other hand, for the UE 12, the time duration of the consecutive uplink subframes is equal to or less than 2.5% of the product of the number of the anchor channels and the dwell time. For example, in Europe where the number of the anchor channels is four (N_{anchor}=4), the time duration of the consecutive downlink subframes T_{DL} will be two fifths of the dwell time D_{well} in a frame of each anchor channel (see FIG. 2). In some embodiments, the downlink subframes are not necessarily arranged in a string, and the same goes with the uplink subframes.

For the downlink transmission, each anchor channel can be used, for example, by the RF circuitry to transmit the PSS, SSS and PBCH content to the UE 12. In some embodiments, each anchor channel can be used, for example by the RF circuitry, as a narrowband physical downlink control channel (NPDCCH) or a narrowband physical downlink shared channel (NPDSCH) for downlink transmission of SIB1-NB-U (Narrowband System Information Block 1). In some embodiments, each anchor channel can be used, for example, by the RF circuitry as a NPDCCH or a NPDSCH for downlink data for paging.

For the uplink transmission, each anchor channel can be used, for example, by the RF circuitry as a physical random access channel (PRACH), an Msg3 physical uplink shared channel (PUSCH) or a physical uplink control channel (PUCCH).

As shown in FIG. 2, the baseband circuitry selects one of the four anchor channels as the transmission channel for the downlink transmission of the DRS. Upon receipt of the PSS/SSS included in the DRS from the RAN node 14, the UE 12 is capable of transmitting signals to the RAN node 14 and receiving signals from the RAN node 14 through the selected one of the anchor channels over a frame. When the dwell time of the frame has elapsed, for channel hopping, the baseband circuitry may select another one of the anchor channels as the transmission channel for the DRS, and then the UE 12 is capable of transmitting and receiving signals through said another one of the anchor channels upon receipt of the DRS again.

In another option of the unified frame structure, with medium-utilization limitation, there is no listen-before-talk (LBT) regulation. The anchor channel is used, for example, by the RF circuitry only for the downlink transmission of the DRS that includes the PSS, SSS and PBCH content. Upon receipt of the DRS, the UE 12 is capable of selecting, according to the DRS, a channel from a plurality of data channels within the unlicensed narrow band for transmitting signals to the RAN node 14 and receiving signals from the RAN node 14 over a frame. When the dwell time of the frame has elapsed, for channel hopping, the UE 12 selects another channel from the plurality of data channels for data transmission upon receipt of the DRS again. The dwell time of the frame, during which a selected one of the data channels is to transmit and receive data, may be determined based on medium-utilization limitation.

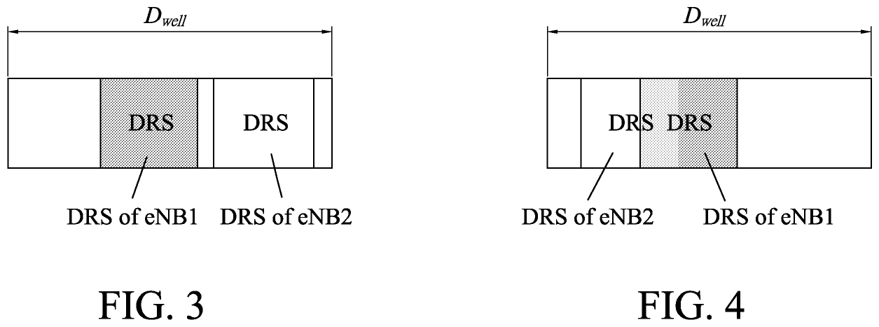

In some embodiments, a subframe in the anchor channel for starting (transmission of) the DRS is randomly selected. FIG. 3 illustrates an example of a frame in the anchor channel where an Evolved Node B (eNB1) randomly selects a subframe for starting the DRS and another Evolved Node B (eNB2) randomly selects another subframe for starting the DRS. In the case shown in FIG. 3, the DRS's transmitted respectively by the eNB1 and eNB2 do not collide with each other. FIG. 4 illustrates another example of a frame in the anchor channel where the eNB1 and the eNB2 randomly select respective subframes for starting the DRS's, and the DRS's transmitted respectively by the eNB1 and eNB2 collide with each other.

In order to reduce probability of collision of the DRS's, in some embodiments, the processors of the baseband circuitry divide a frame in each anchor channel into multiple orthogonal subframes, and randomly select one of the orthogonal subframes for the DRS. In some embodiments, the processors of the baseband circuitry are to determine, according to the cell ID associated with the RAN node 14, a subframe in the anchor channel for starting the DRS.

Non-Unified Frame Structure

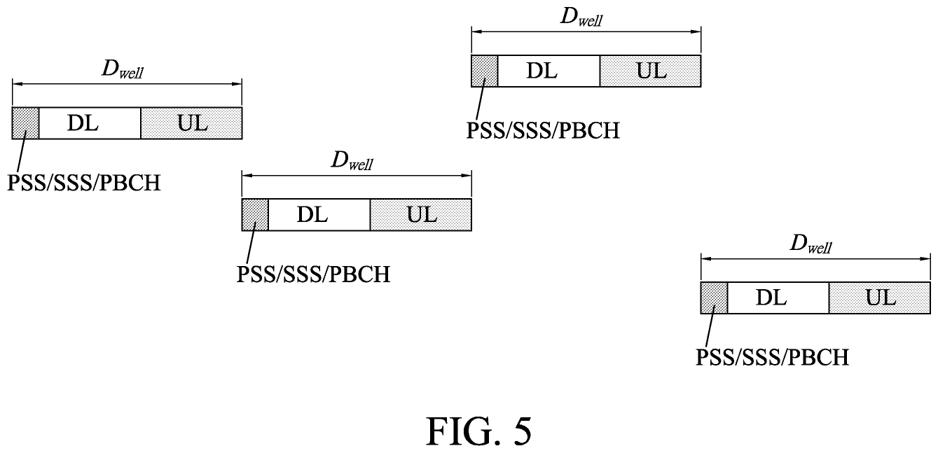

In some embodiments, different frame structures are applied to different regions. For example, non-unified frame structure can be applied to Europe while the unified frame structure is applied to United States as described in the above. In the non-unified frame structure, there is no explicit anchor channel, and each channel within the unlicensed narrow band can be selected, for example, by the baseband circuitry, as the transmission channel for the DRS including the PSS, the SSS and the PBCH content. The RF circuitry is configured to use the plurality of channels each as one of a narrowband physical downlink control channel (NPDCCH), a narrowband physical downlink shared channel (NPDSCH) and a physical uplink shared channel (PUSCH) for broadcasting and unicasting data. In some embodiments, the processors of the baseband circuitry also select the transmission channel as the communication channel for the uplink data and the downlink data. Referring to FIG. 5, the baseband circuitry selects one of the four channels as the transmission channel for the downlink transmission of the DRS over a frame with uplink subframes and downlink subframes. Upon receipt of the PSS/SSS included in the DRS from the RAN node 14, the UE 12 is capable of transmitting signals to the RAN node 14 and receiving signals from the RAN node 14 through the selected one of the four channels. When the dwell time of the frame has elapsed, for channel hopping, the baseband circuitry may select another one of the four channels as the transmission channel for the DRS, and then the UE 12 is capable of transmitting and receiving signals through said another one of the four channel upon receipt of the DRS again. The dwell time of the frame, during which a selected one of the channels is to transmit and receive data, may be determined based on medium-utilization limitation.

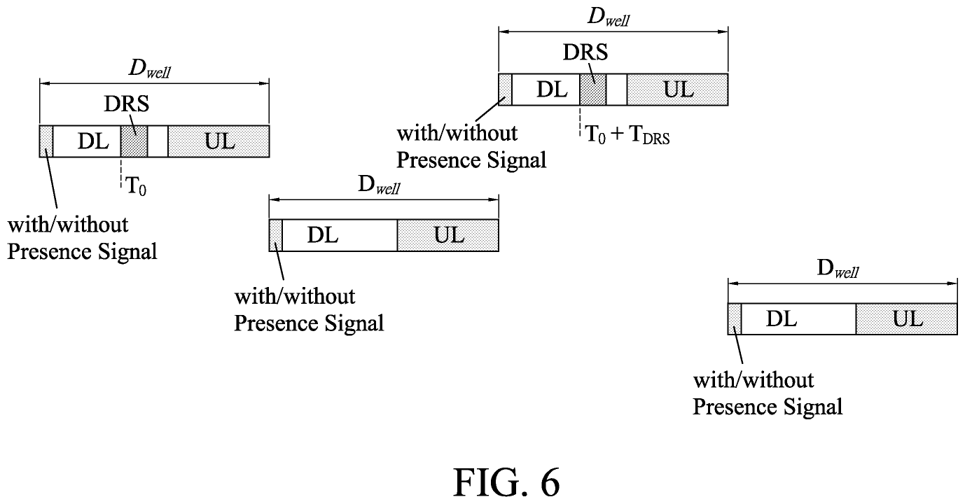

In some embodiments of the non-unified frame structure, there is a presence signal at beginning of each frame (see FIG. 6). The baseband circuitry first detects, from among a plurality of channels within the unlicensed narrow band, a free channel that is unoccupied. Then, the RF circuitry provides a presence signal at the beginning of a frame in the free channel to notify the UE 12 of the free channel. Accordingly, the UE 12 may skip other channels that are occupied, and transmit and receive data through the free channel upon receipt of the presence signal. In an alternative embodiment, the RF circuitry does not provide the presence signal in a frame, and each of the plurality of channels within the unlicensed narrow band can be used for downlink data and uplink data without channel skipping. In some embodiments, the DRS is transmitted periodically. In a case that an interval between two consecutive transmissions of the DRS is an integer number of times of the dwell time, the DRS will not be transmitted on all channels and will only be transmitted on the channel having the frame that overlaps in time with the transmission of the DRS. Referring to FIG. 6, the DRS is first transmitted at time point T₀ over the first frame, and then is transmitted again at time point T₀+T_{DRS} over the third frame, where T_{DRS} is the interval between two consecutive transmissions of the DRS and is double the dwell time D_{well}. In the example given in FIG. 6, the DRS will not be transmitted on the two channels having the second and fourth frames.

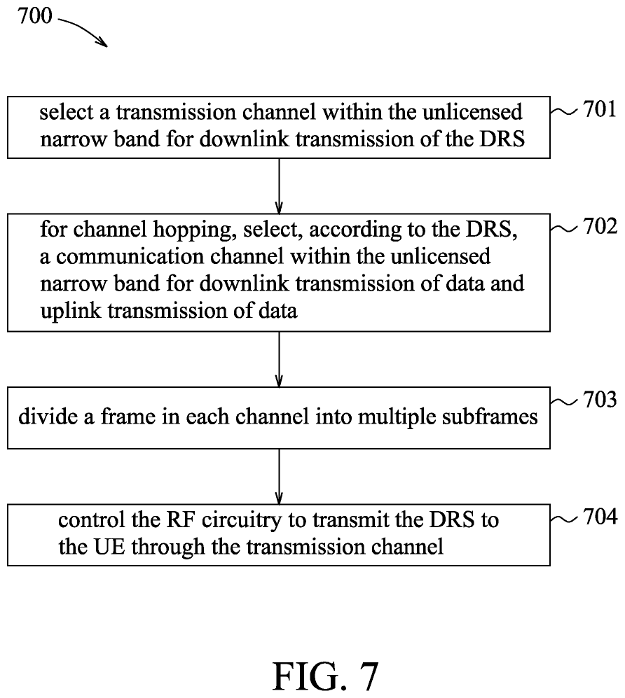

Referring to FIG. 7, a method 700 for unlicensed narrowband transmission to support IoT service is described. The method 700 may be implemented as one or more modules in executable software as a set of logic instructions stored in a machine- or computer-readable storage medium of a memory such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

In block 701, the baseband circuitry of the RAN node 14 selects a transmission channel within the unlicensed narrow band for downlink transmission of the DRS that includes the PSS, the SSS and the PBCH content. In some embodiments of the unified frame structure, the baseband circuitry predetermines at least one anchor channel as the transmission channel according to the cell ID of the RAN node 14. In some embodiments of the non-unified frame structure, the baseband circuitry selects one of the plurality of channels within the unlicensed narrow band as the transmission channel for the DRS.

In block 702, for channel hopping, the baseband circuitry selects, according to the DRS, a communication channel within the unlicensed narrow band for downlink data and uplink data. In some embodiments of the unified frame structure, the baseband circuitry selects the anchor channel as the communication channel. In some embodiments of the unified frame structure, the baseband circuitry selects one of the plurality of channels as the communication channel according to the DRS. In some embodiments of the non-unified frame structure, the baseband circuitry selects the selected one of the plurality of channels for the DRS as the communication channel.

In block 703, the baseband circuitry divides a frame in each channel into multiple subframes. In some embodiments, the baseband circuitry divides a frame in each anchor channel into consecutive downlink subframes and consecutive uplink subframes. In some embodiments, the baseband circuitry divides a frame in each anchor channel into multiple orthogonal subframes.

In block 704, the baseband circuitry controls the RF circuitry to transmit the DRS to the UE 12 through the transmission channel. In some embodiments of the unified frame structure, the RF circuitry uses the anchor channel as the PRACH, the Msg3 PUSCH and/or the PUCCH for the uplink data. In some embodiments of the non-unified frame structure, the RF circuitry uses the selected one of the plurality of channels as the NPDCCH, the NPDSCH and/or the PUSCH for broadcasting and unicasting data. In some embodiments, the baseband circuitry determines, according to the cell ID of the RAN node 14, a subframe in the anchor channel for starting the DRS. In some embodiments, the baseband circuitry randomly selects one of the orthogonal subframes for the DRS so as to reduce probability of collision of the DRS's.

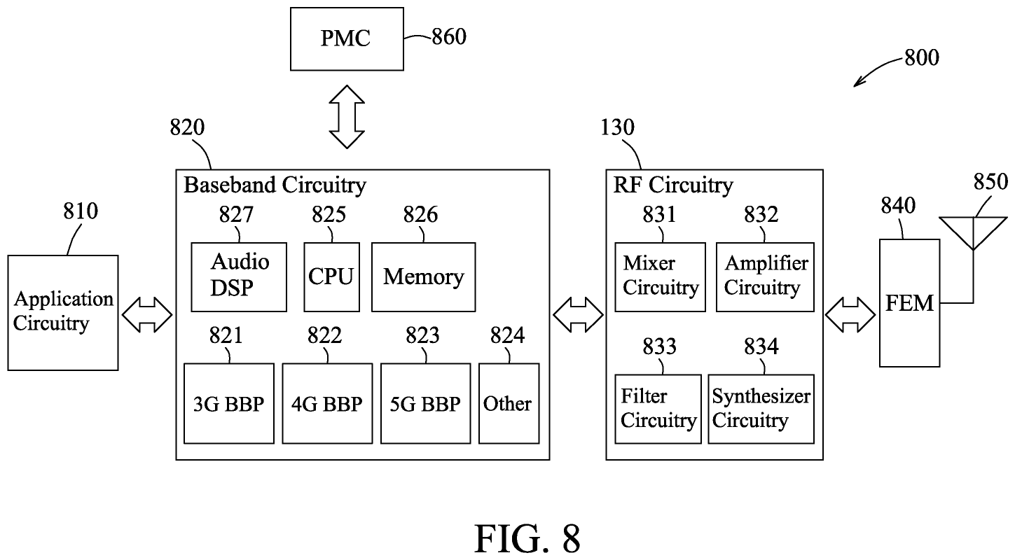

FIG. 8 illustrates an example of an apparatus 800 operable for unlicensed narrowband transmission to support Internet-of-Things (IoT) service. For example, the apparatus 800 may be included in a user equipment (UE) or a radio access network (RAN) node. In this embodiment, the apparatus 800 includes an application circuitry 810, a baseband circuitry 820, a radio frequency (RF) circuitry 830, a front-end module (FEM) circuitry 840, one or more antennas 850 (only one is depicted) and a power management circuitry (PMC) 860. In some embodiments, the apparatus 800 may include fewer components. For example, a RAN node may not include the application circuitry 810, and instead include a processor/controller to process Internet-Protocol (IP) data received from an evolved packet core (EPC) network. In other embodiments, the apparatus 800 may include additional components, for example, a memory/storage device, a display, a camera, a sensor or an input/output (I/O) interface. In some embodiments, the above-mentioned components may be included in more than one device. For example, in order to implement a Cloud-RAN architecture, the above-mentioned circuitries may be separated and included in two or more devices in the Cloud-RAN architecture.

The application circuitry 810 may include one or more application processors. For example, the application circuitry 810 may include, but is not limited to, one or more single-core or multi-core processors. The processors may include any combination of general-purpose processors and dedicated processors (e.g., graphics processors, application processors, etc.). The processors may be coupled to or include a memory/storage module, and may be configured to execute instructions stored in the memory/storage module to enable various applications or operating systems to run on the apparatus 800. In some embodiments, the processors of the application circuitry 810 may process IP data packets received from an EPC network.

In some embodiments, the baseband circuitry 820 may provide for communication compatible with one or more radio technologies. For example, in some embodiments, the baseband circuitry 820 may support communication with an evolved universal terrestrial radio access network (EUTRAN) or other wireless metropolitan area networks (WMAN), a wireless local area network (WLAN), or a wireless personal area network (WPAN). In some embodiments where the baseband circuitry 820 is configured to support radio communication using more than one wireless protocol, the baseband circuitry 820 may be referred to as a multi-mode baseband circuitry.

The baseband circuitry 820 may include, but is not limited to, one or more single-core or multi-core processors. The baseband circuitry 820 may include one or more baseband processors or control logic to process baseband signals received from the RF circuitry 830, and to generate baseband signals to be transmitted to the RF circuitry 830. The baseband circuitry 820 may interface and communicate with the application circuitry 810 for generation and processing of the baseband signals and for controlling operations of the RF circuitry 830.

In some embodiments, the baseband circuitry 820 may include a third generation (3G) baseband processor (3G BBP) 821, a fourth generation (4G) baseband processor (4G BBP) 822, a fifth generation (5G) baseband processor (5G BBP) 823 and other baseband processor(s) 824 for other existing generations, generations in development or to be developed in the future (e.g., second generation (2G), sixth generation (6G), etc.). The baseband processors 821-824 of the baseband circuitry 820 are configured to handle various radio control functions that enable communication with one or more radio networks via the RF circuitry 830. In other embodiments, the baseband circuitry 820 may further include a central processing unit (CPU) 825 and a memory 826, and some or all functionality (e.g., the radio control functions) of the baseband processors 821-824 may be implemented as software modules that are stored in the memory 826 and executed by the CPU 825 to carry out the functionality. The radio control functions of the baseband processors 821-824 may include, but are not limited to, signal modulation/demodulation, encoding/decoding, radio frequency shifting, etc. In some embodiments, the signal modulation/demodulation includes Fast-Fourier Transform (FFT), pre-coding or constellation mapping/de-mapping. In some embodiments, the encoding/decoding includes convolution, tail-biting convolution, turbo, Viterbi, or Low Density Parity Check (LDPC) encoding/decoding. Embodiments of the signal modulation/demodulation and the encoding/decoding are not limited to these examples and may include other suitable operations in other embodiments. In some embodiments, the baseband circuitry 820 may further include an audio digital signal processor (DSP) 827 for compression/decompression and echo cancellation.

In some embodiments, the components of the baseband circuitry 820 may be integrated as a single chip or a single chipset, or may be disposed on a single circuit board. In some embodiments, some or all of the constituent components of the baseband circuitry 820 and the application circuitry 810 may be integrated as, for example, a system on chip (SoC).

The RF circuitry 830 is configured to enable communication with wireless networks using modulated electromagnetic radiation through a non-solid medium. In various embodiments, the RF circuitry 830 may include switches, filters, amplifiers, etc., to facilitate communication with the wireless network. The RF circuitry 830 may include a receive signal path that includes circuitry to down-convert RF signals received from the FEM circuitry 840 and to provide the baseband signals to the baseband circuitry 820. The RF circuitry 830 may further include a transmit signal path that includes circuitry to up-convert the baseband signals provided by the baseband circuitry 820 and to provide RF output signals to the FEM circuitry 840 for transmission.

In some embodiments, the receive signal path of the RF circuitry 830 may include mixer circuitry 831, amplifier circuitry 832 and filter circuitry 833. In some embodiments, the transmit signal path of the RF circuitry 830 may include filter circuitry 833 and mixer circuitry 831. The RF circuitry 830 may also include synthesizer circuitry 834 for synthesizing a frequency for use by the mixer circuitry 831 of the receive signal path and/or the transmit signal path.

For the receive signal path, in some embodiments, the mixer circuitry 831 may be configured to down-convert RF signals received from the FEM circuitry 840 based on the synthesized frequency provided by synthesizer circuitry 834. The amplifier circuitry 832 may be configured to amplify the down-converted signals. The filter circuitry 833 may be a low-pass filter (LPF) or a band-pass filter (BPF) configured to remove unwanted signals from the down-converted signals to generate output baseband signals. The output baseband signals may be provided to the baseband circuitry 820 for further processing. In some embodiments, the output baseband signals may be zero-frequency baseband signals, although this is not a requirement. In some embodiments, the mixer circuitry 831 of the receive signal path may include passive mixers, although the scope of the embodiments is not limited in this respect.

As for the transmit signal path, in some embodiments, the mixer circuitry 831 may be configured to up-convert input baseband signals based on the synthesized frequency provided by the synthesizer circuitry 834 to generate the RF output signals for the FEM circuitry 840. The input baseband signals may be provided by the baseband circuitry 820, and may be filtered by the filter circuitry 833.

In some embodiments, the mixer circuitry 831 of the receive signal path and the mixer circuitry 831 of the transmit signal path may include two or more mixers and may be arranged for quadrature down-conversion in the receive signal path and for quadrature up-conversion in the transmit signal path. In some embodiments, the mixer circuitry 831 of the receive signal path and the mixer circuitry 831 of the transmit signal path may include two or more mixers and may be arranged for image rejection (e.g., Hartley image rejection). In some embodiments, the mixer circuitry 831 of the receive signal path and the mixer circuitry 831 of the transmit signal path may be arranged for direct down-conversion and direct up-conversion, respectively. In some embodiments, the mixer circuitry 831 of the receive signal path and the mixer circuitry 831 of the transmit signal path may be configured for super-heterodyne operation.

In some embodiments, the output baseband signals and the input baseband signals may be analog baseband signals, although the scope of the embodiments is not limited in this respect. In alternative embodiments, the output baseband signals and the input baseband signals may be digital baseband signals. In such alternative embodiments, the RF circuitry 830 may further include analog-to-digital converter (ADC) circuitry and digital-to-analog converter (DAC) circuitry, and the baseband circuitry 820 may include a digital baseband interface to communicate with the RF circuitry 830.

In some dual-mode embodiments, a separate radio IC circuitry may be provided for processing signals for each spectrum, although the scope of the embodiments is not limited in this respect.

In some embodiments, the synthesizer circuitry 834 may be a fractional-N synthesizer or a fractional N/N+1 synthesizer, although the scope of the embodiments is not limited in this respect as other types of frequency synthesizers may be suitable. For example, the synthesizer circuitry 834 may be a delta-sigma synthesizer, a frequency multiplier, or a synthesizer comprising a phase-locked loop with a frequency divider in other embodiments.

The synthesizer circuitry 834 may be configured to synthesize an output frequency for use by the mixer circuitry 831 of the RF circuitry 830 based on a frequency input and a divider control input. In some embodiments, the frequency input may be provided by a voltage controlled oscillator (VCO), although that is not a requirement. In some embodiments, the divider control input may be provided by either the baseband circuitry 820 or the application circuitry 810 depending on the desired output frequency. In some embodiments, the divider control input (e.g., N) may be determined according to a look-up table based on a channel indicated by the application circuitry 810.

The synthesizer circuitry 834 of the RF circuitry 830 may include a divider, a delay-locked loop (DLL), a multiplexer and a phase accumulator. In some embodiments, the divider may be a dual modulus divider (DMD), and the phase accumulator may be a digital phase accumulator (DPA). In some embodiments, the DMD may be configured to divide an input signal by either N or N+1 (e.g., based on a carry out) to provide a fractional division ratio. In some embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is a number of the delay elements in the delay line. In this way, the DLL provides negative feedback to help ensure that the total delay through the delay line is one VCO cycle.

In some embodiments, the synthesizer circuitry 834 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 830 may include an IQ/polar converter.

The FEM circuitry 840 may include a receive signal path that includes circuitry configured to operate on RF signals received from the one or more antennas 850, to amplify the received RF signals and to provide amplified versions of the received RF signals to the RF circuitry 830 for further processing. The FEM circuitry 840 may further include a transmit signal path that includes circuitry configured to amplify signals provided by the RF circuitry 830 for transmission by one or more of the one or more antennas 850. In various embodiments, the amplification through the transmit or receive signal path may be done solely in the RF circuitry 830, solely in the FEM circuitry 840, or in both the RF circuitry 830 and the FEM circuitry 840.

In some embodiments, the FEM circuitry 840 may include a TX/RX switch to switch between transmit mode operation and receive mode operation. The receive signal path of the FEM circuitry 840 may include a low-noise amplifier (LNA) to amplify the received RF signals and to provide the amplified versions of the received RF signals as an output (e.g., to the RF circuitry 830). The transmit signal path of the FEM circuitry 840 may include a power amplifier (PA) to amplify input RF signals (e.g., provided by the RF circuitry 830), and one or more filters to generate RF signals for subsequent transmission (e.g., by one or more of the one or more antennas 850).

In some embodiments, the PMC 860 is configured to manage power provided to the baseband circuitry 820. In particular, the PMC 860 may control power-source selection, voltage scaling, battery charging, or DC-to-DC conversion. The PMC 860 may often be included in the apparatus 800 when the apparatus 800 is capable of being powered by a battery. For example, when the apparatus 800 is included in a UE, it generally includes the PMC 860. The PMC 860 may increase the power conversion efficiency while providing desirable implementation size and heat dissipation characteristics.

While FIG. 8 shows the PMC 860 being coupled only with the baseband circuitry 820, in other embodiments, the PMC 860 may be additionally or alternatively coupled with, and perform similar power management operations for, other components such as, but not limited to, the application circuitry 810, the RF circuitry 830 or the FEM 840.

In some embodiments, the PMC 860 may control, or otherwise be part of, various power saving mechanisms of the apparatus 800. For example, if the apparatus 800 is in an RRC_Connected state, where it is still connected to the RAN node 14 as it expects to receive traffic shortly, then it may enter a state known as Discontinuous Reception Mode (DRX) after a period of inactivity. During this state, the apparatus 800 may power down for brief intervals of time and thus save power.

If there is no data traffic activity for an extended period of time, then the apparatus 800 may enter an RRC_Idle state, where it disconnects from network and does not perform operations such as channel quality feedback, handover, etc. The apparatus 800 goes into a very low power state and it performs paging where it periodically wakes up to listen to the network and then powers down again. The apparatus 800 may not receive data in this state. In order to receive data, the apparatus 800 must transition back to the RRC_Connected state.

An additional power saving mode may allow a device or apparatus to be unavailable to the network for periods longer than a paging interval (ranging from seconds to a few hours). During this time, the device or apparatus is totally unreachable to the network and may power down completely. Any data sent during this time incurs a large delay and it is assumed the delay is acceptable.

Processors of the application circuitry 810 and processors of the baseband circuitry 820 may be used to execute elements of one or more instances of a protocol stack. For example, processors of the baseband circuitry 820, alone or in combination, may be used to execute Layer 3, Layer 2, or Layer 1 functionality, while processors of the application circuitry 810 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

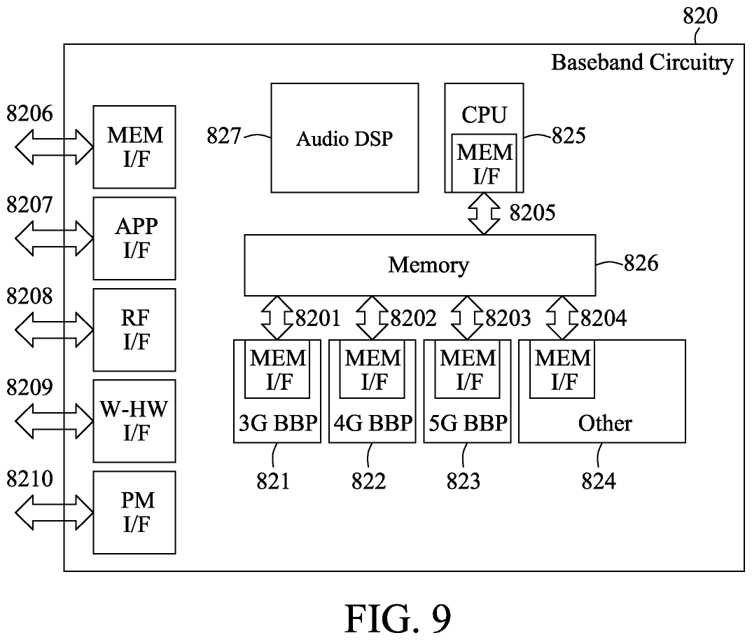

FIG. 9 illustrates example interfaces of baseband circuitry in accordance with some embodiments. As discussed above, the baseband circuitry 820 of FIG. 8 includes various processors (i.e., the baseband processors 821-824 and the CPU 825), and the memory 826 utilized by the processors. Each of the processors 821-825 may include an internal memory interface (MEM I/F) 8201-8205 communicatively coupled to the memory 826 so as to send/receive data to/from the memory 826.

The baseband circuitry 820 may further include one or more interfaces to communicatively couple to other circuitries/devices. The one or more interfaces include, for example, a memory interface (MEM I/F) 8206 (e.g., an interface to send/receive data to/from memory external to the baseband circuitry 820), an application circuitry interface (APP I/F) 8207 (e.g., an interface to send/receive data to/from the application circuitry 810 of FIG. 8), an RF circuitry interface (RF I/F) 8208 (e.g., an interface to send/receive data to/from the RF circuitry 830 of FIG. 8), a wireless hardware connectivity interface (W-HW I/F) 8209 (e.g., an interface to send/receive data to/from Near Field Communication (NFC) components, Bluetooth® components (e.g., Bluetooth® Low Energy), Wi-Fi® components, and/or other communication components), and a power management interface (PM I/F) 8210 (e.g., an interface to send/receive power or control signals to/from the PMC 860 of FIG. 8).

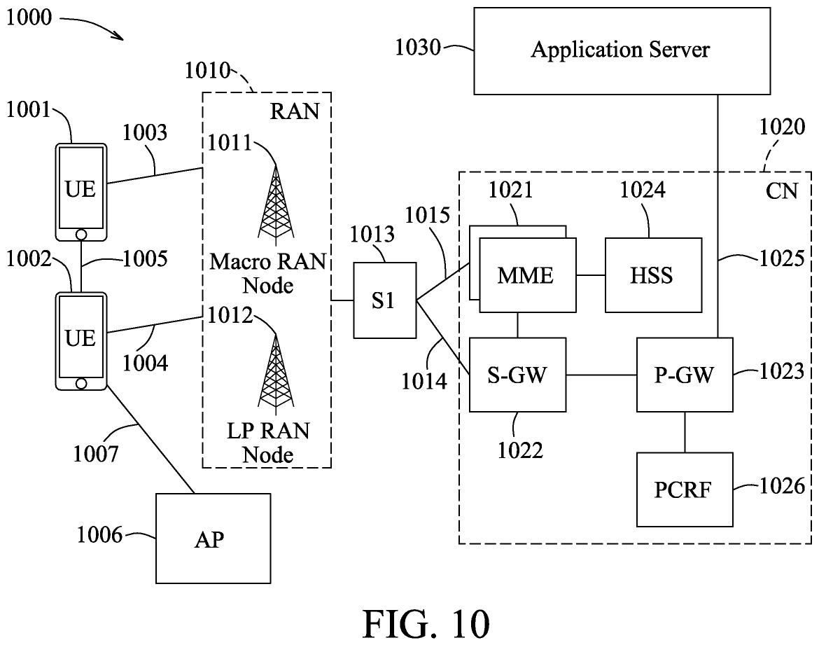

FIG. 10 illustrates an architecture of a system 1000 of a network in accordance with some embodiments of this disclosure. The system 1000 is shown to include a user equipment (UE) 1001 and a UE 1002. The UEs 1001 and 1002 are illustrated as smartphones (e.g., handheld touchscreen mobile computing devices connectable to one or more cellular networks), but may also include any mobile or non-mobile computing device, such as Personal Data Assistants (PDAs), pagers, laptop computers, desktop computers, wireless handsets, or any computing device including a wireless communications interface.

In some embodiments, at least one of the UEs 1001 and 1002 may be an Internet-of-Things (IoT) UE, which can include a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UE may execute background applications (e.g., keep-alive messages, status updates, etc.) to facilitate the connections of the IoT network.

The UEs 1001 and 1002 may be configured to connect, e.g., communicatively couple, with a radio access network (RAN) 1010. The RAN 1010 may be, for example, an Evolved Universal Mobile Telecommunications System (UMTS) Terrestrial Radio Access Network (E-UTRAN), a NextGen RAN (NG RAN), or some other type of RAN. The UEs 1001 and 1002 utilize connections 1003 and 1004, respectively. Each of the connections 1003 and 1004 includes a physical communications interface or layer (discussed in further detail below). In this embodiment, the connections 1003 and 1004 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1001 and 1002 may further directly exchange communication data via a ProSe interface 1005. The ProSe interface 1005 may alternatively be referred to as a sidelink interface including one or more logical channels. The one or more logical channels include, but are not limited to, a Physical Sidelink Control Channel (PSCCH), a Physical Sidelink Shared Channel (PSSCH), a Physical Sidelink Discovery Channel (PSDCH) and a Physical Sidelink Broadcast Channel (PSBCH).

The UE 1002 is shown to be configured to access an access point (AP) 1006 via connection 1007. The connection 1007 may include a local wireless connection, such as a connection consistent with any IEEE 802.11 protocol, wherein the AP 1006 may include a wireless fidelity (WiFi®) router. In this example, the AP 1006 is shown to be connected to the Internet without connecting to a core network 1020 of the wireless system 1000 (described in further detail below).

The RAN 1010 can include one or more access nodes that enable the connections 1003 and 1004. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). In some embodiments, the RAN 1010 may include one or more RAN nodes for providing macrocells, e.g., macro RAN node 1011, and one or more RAN nodes for providing femtocells or picocells (e.g., cells having smaller coverage areas, smaller user capacity, or higher bandwidth compared to macrocells), e.g., low power (LP) RAN node 1012.

Any one of the RAN nodes 1011 and 1012 can terminate the air interface protocol and can be the first point of contact for the UEs 1001 and 1002. In some embodiments, any one of the RAN nodes 1011 and 1012 can fulfill various logical functions for the RAN 1010 including, but not limited to, radio network controller (RNC) functions such as radio bearer management, uplink and downlink dynamic radio resource management and data packet scheduling, and mobility management.

According to some embodiments, the UEs 1001 and 1002 can be configured to communicate using Orthogonal Frequency-Division Multiplexing (OFDM) communication signals with each other or with any of the RAN nodes 1011 and 1012 over a multicarrier communication channel in accordance with various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications). It is noted that the scope of the embodiments is not limited in this respect. The OFDM signals may include a plurality of orthogonal subcarriers.

In some embodiments, a downlink resource grid can be used for downlink transmissions from any one of the RAN nodes 1011 and 1012 to the UEs 1001 and 1002, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that can currently be allocated. There are several different physical downlink channels that are conveyed using such resource blocks.

The PDSCH may carry user data and higher-layer signaling to the UEs 1001 and 1002. The PDCCH may carry information about the transport format and resource allocations related to the PDSCH, among other things. The PDCCH may also inform the UEs 1001 and 1002 about the transport format, resource allocation, and H-ARQ (Hybrid Automatic Repeat Request) information related to the uplink shared channel. Typically, downlink scheduling (assigning control and shared channel resource blocks to a UE within a cell) may be performed at any of the RAN nodes 1011 and 1012 based on channel quality information fed back from any one of the UEs 1001 and 1002. The downlink resource assignment information may be sent on the PDCCH used for (e.g., assigned to) each of the UEs 1001 and 1002.

The PDCCH may use control channel elements (CCEs) to convey the control information. Before being mapped to resource elements, PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced control channel elements (ECCEs). Similar to above, each ECCE may correspond to nine sets of four physical resource elements known as enhanced resource element groups (EREGs). One of the ECCEs may have other numbers of EREGs in some situations.

The RAN 1010 is shown to be communicatively coupled to the core network (CN) 1020 via an S1 interface 1013. In some embodiments, the CN 1020 may be an evolved packet core (EPC) network, a NextGen Packet Core (NPC) network, or some other type of CN. In this embodiment the S1 interface 1013 is split into two parts, including an S1-U interface 1014 and an S1-mobility management entity (MME) interface 1015. The S1-U interface 1014 carries traffic data between the RAN nodes 1011 and 1012 and a serving gateway (S-GW) 1022. The S1-MME interface 1015 is a signaling interface between the RAN nodes 1011 and 1012 and MMEs 1021.

In this embodiment, the CN 1020 includes the MMEs 1021, the S-GW 1022, a Packet Data Network (PDN) Gateway (P-GW) 1023, and a home subscriber server (HSS) 1024. The MMEs 1021 may be similar in function to the control plane of legacy Serving General Packet Radio Service (GPRS) Support Nodes (SGSN). The MMEs 1021 may manage mobility aspects in access such as gateway selection and tracking area list management. The HSS 1024 may include a database for network users, including subscription-related information to support the network entities' handling of communication sessions. The CN 1020 may include one or several HSSs 1024, depending on the number of mobile subscribers, on the capacity of the equipment, on the organization of the network, etc. For example, the HSS 1024 can provide support for routing/roaming, authentication, authorization, naming/addressing resolution, location dependencies, etc.

The S-GW 1022 terminates the S1 interface 1013 towards the RAN 1010, and routes data packets between the RAN 1010 and the CN 1020. In addition, the S-GW 1022 may be a local mobility anchor point for inter-RAN node handovers, and also may provide an anchor for inter-3GPP mobility. Other responsibilities of the S-GW 1022 may include lawful intercept, charging, and some policy enforcement.

The P-GW 1023 terminates an SGi interface toward a PDN. The P-GW 1023 routes data packets between the CN 1020 (e.g., the EPC network) and external networks such as a network including an application server 1030 (alternatively referred to as application function (AF)) via an Internet Protocol (IP) interface 1025. Generally, the application server 1030 may be an element offering applications that use IP bearer resources with the core network 1020 (e.g., UMTS Packet Services (PS) domain, LTE PS data services, etc.). In this embodiment, the P-GW 1023 is shown to be communicatively coupled to the application server 1030 via the IP interface 1025. The application server 1030 can also be configured to support one or more communication services (e.g., Voice-over-Internet Protocol (VoIP) sessions, PTT sessions, group communication sessions, social networking services, etc.) for the UEs 1001 and 1002 via the CN 1020.

In some embodiments, the P-GW 1023 may further be a node for policy enforcement and charging data collection. The CN 1020 may further include a policy and charging control element (e.g., Policy and Charging Enforcement Function (PCRF) 1026). In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1026 may be communicatively coupled to the application server 1030 via the P-GW 1023. The application server 1030 may signal the PCRF 1026 to indicate a new service flow and select appropriate Quality of Service (QoS) and charging parameters. The PCRF 1026 may provision this rule into a Policy and Charging Enforcement Function (PCEF) (not shown) with appropriate traffic flow template (TFT) and QoS class of identifier (QCI), which commences the QoS and charging as specified by the application server 1030.

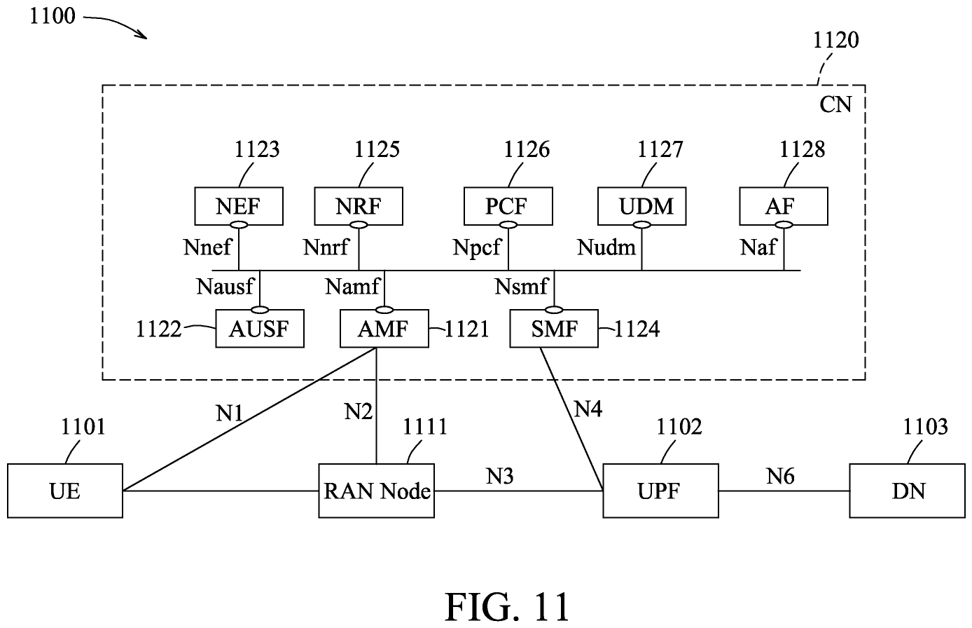

FIG. 11 illustrates another architecture of a system 1100 of a network according to some embodiments of this disclosure. The system 1100 is shown to include a UE 1101, a RAN node 1111, a User Plane Function (UPF) 1102, a data network (DN) 1103, and a 5G Core Network (5GC) 1120. In some embodiments, the UE 1101 may be the same as or similar to UEs 1001 and 1002 discussed with reference to FIG. 10 previously, and the RAN node 1111 may be the same or similar to the RAN nodes 1011 and 1012 discussed with reference to FIG. 10 previously. The DN 1103 may be, for example, various network operator services, Internet access or third party services.

The 5GC 1120 may include an Authentication Server Function (AUSF) 1122, a Core Access and Mobility Management Function (AMF) 1121, a Session Management Function (SMF) 1124, a Network Exposure Function (NEF) 1123, a Policy Control function (PCF) 1126, a Network Function (NF) Repository Function (NRF) 1125, a Unified Data Management (UDM) 1127, and an Application Function (AF) 1128. The 5GC 1120 may also include other elements that are not shown, such as a Structured Data Storage network function (SDSF), an Unstructured Data Storage network function (UDSF), and the like.

The UPF 1102 may act as an anchor point for intra-RAT and inter-RAT mobility, an external PDU (protocol data unit) session point of interconnect to the DN 1103, and a branching point to support multi-homed PDU session. The UPF 1102 may also be used to perform packet routing and forwarding, to perform packet inspection, to enforce user plane part of policy rules, to lawfully intercept packets (UP collection), to handle traffic usage reporting, to perform QoS handling for user plane (e.g. packet filtering, gating, UL/DL rate enforcement), to perform Uplink Traffic verification (e.g., SDF to QoS flow mapping), to transport level packet marking in the uplink and downlink, and to perform downlink packet buffering and downlink data notification triggering. The UPF 1102 may include an uplink classifier to support routing traffic flows to a data network. The DN 1103 may include, or be similar to the application server 1030 discussed with reference to FIG. 10 previously.

The AUSF 1122 may store data for authentication of the UE 1101, handle authentication related functionality, and facilitate a common authentication framework for various access types.

The AMF 1121 may be responsible for registration management (e.g., for registering the UE 1101, etc.), connection management, reachability management, mobility management, lawful interception of AMF-related events, and access authentication and authorization. The AMF 1121 may provide transport for short message service (SMS) messages between the UE 1101 and the SMF 1124, and act as a transparent proxy for routing SMS messages. The AMF 1121 may also provide transport for SMS messages between the UE 1101 and an SMS function (SMSF) (not shown). The AMF 1121 may act as Security Anchor Function (SEA), which may include interaction with the AUSF 1122 and the UE 1101 and which may be used to receive an intermediate key that was established as a result of authentication process for the UE 1101. In a case that USIM-based authentication is used, the AMF 1121 may retrieve the security material from the AUSF 1122. The AMF 1121 may also include a Security Context Management (SCM) function that receives a key from the SEA and that uses the key from the SEA to derive access-network specific keys. Furthermore, the AMF 1121 may be a termination point of RAN CP interface (N2 reference point) or a termination point of NAS (N1) signaling, and may be used to perform NAS ciphering and integrity protection.

The AMF 1121 may also support NAS signaling with the UE 1101 over an N3 interworking-function (IWF) interface. The N3IWF interface may be used to provide access to untrusted entities. The N3IWF interface may be a termination point for the N2 and N3 interfaces for control plane and user plane, respectively, and as such, may be used to handle N2 signaling from the SMF 1124 and the AMF 1121 for PDU sessions and QoS, to encapsulate/de-encapsulate packets for IPSec and N3 tunneling, to mark N3 user-plane packets in the uplink, and to enforce QoS corresponding to N3 packet marking while taking into account QoS requirements associated with such marking received over N2. The N3IWF interface may also relay uplink and downlink control-plane NAS (N1) signaling between the UE 1101 and the AMF 1121, and relay uplink and downlink user-plane packets between the UE 1101 and the UPF 1102. The N3IWF interface also provides mechanisms for IPsec tunnel establishment with the UE 1101.

The SMF 1124 may be responsible for: session management (e.g., session establishment, modification and release, including tunnel maintaining between the UPF 1102 and the RAN node 1111); UE IP address allocation and management (including optional authorization); selection and control of UP function; configuring traffic steering at UPF to route traffic to proper destination; termination of interfaces towards Policy control functions; controlling part of policy enforcement and QoS; lawful interception (for SMS events and interface to LI System); termination of SMS parts of NAS messages; downlink data notification; acting as an initiator of AN specific SMS information, sent via the AMF 1121 over the N2 interface to the RAN node 1111; and determining SSC mode of a session. The SMF 1124 may include the following roaming functionality: handling local enforcement to apply QoS SLAB (VPLMN); charging data collection and charging interface (VPLMN); lawful interception (in VPLMN for SMS events and interface to LI System); and support for interaction with external DN for transport of signaling for PDU session authorization/authentication by external DN.

The NEF 1123 may provide means for securely exposing the services and capabilities provided by 3GPP network functions for third party, internal exposure/re-exposure, Application Functions (e.g., the AF 1128), edge computing or fog computing systems, etc. In such embodiments, the NEF 1123 may authenticate, authorize, and/or throttle the AFs. The NEF 1123 may also translate information exchanged with the AF 1128 and information exchanged with internal network functions. For example, the NEF 1123 may translate an AF-Service-Identifier into an internal SGC information, or vice versa. The NEF 1123 may also receive information from other network functions (NFs) based on exposed capabilities of other network functions. The information from other NFs may be stored in the NEF 1123 as structured data, or stored in a data storage NF using standardized interfaces. The stored information can then be re-exposed by the NEF 1123 to other NFs and AFs, and/or used for other purposes such as analytics.

The NRF 1125 may support service discovery functions, receive NF Discovery Requests from NF instances, and provide the information of the discovered NF instances to the NF instances. The NRF 1125 also maintains information of available NF instances and the supported services.

The PCF 1126 may provide policy rules to control plane function(s) to enforce them, and may also support unified policy framework to govern network behavior. The PCF 126 may also implement a front end (FE) to access subscription information relevant to policy decisions in a user data repository of the UDM 1127.

The UDM 1127 may handle subscription-related information to support the network entities' handling of communication sessions, and may store subscription data of the UE 1101. The UDM 1127 may include two parts, i.e., an application FE and a User Data Repository (UDR). In some embodiments, the UDM 1127 may include a UDM-FE that is in charge of processing of credentials, location management, subscription management and so on. Several different front ends may serve the same user in different transactions. The UDM-FE accesses subscription information stored in the UDR, and performs, for example, authentication credential processing, user identification handling, access authorization, registration/mobility management, and subscription management. The UDR may interact with the PCF 1126. The UDM 1127 may also support SMS management, wherein an SMS-FE implements the similar application logic as discussed previously.

The AF 1128 is configured to provide application influence on traffic routing, to access the Network Capability Exposure (NCE), and to interact with the policy framework for policy control. The NCE may be a mechanism that allows the 5GC 1120 and the AF 1128 to provide information to each other via the NEF 1123, which may be used for edge computing implementations. In such implementations, the network operator and the third party services may be hosted on an access point close to the UE 1101 to achieve efficient service delivery through the reduced end-to-end latency and load on the transport network. For edge computing implementations, the 5GC 1120 may select the UPF 1102 close to the UE 1101 and execute traffic steering from the UPF 1102 to the DN 1103 via the N6 interface. This may be based on the UE subscription data, UE location, and information provided by the AF 1128. In this way, the AF 1128 may influence UPF (re)selection and traffic routing. Based on operator deployment, when the AF 1128 is considered to be a trusted entity, the network operator may permit the AF 1128 to interact directly with relevant NFs.

As discussed previously, the 5GC 1120 may include an SMSF, which may be responsible for SMS subscription checking and verification, and relaying SMS messages between the UE 1101 and other entities, such as an SMS-GMSC/IWMSC/SMS-router. The SMSF may also interact with the AMF 1121 and the UDM 1127 for notification procedure to notify that the UE 1101 is available for SMS transfer (e.g., by setting a UE not reachable flag, and notifying the UDM 1127 when the UE 1101 is available for SMS).

The system 1100 may include the following service-based interfaces, including a service-based interface (Namf) for the AMF 1121, a service-based interface (Nsmf) for the SMF 1124, a service-based interface (Nnef) for the NEF 1123, a service-based interface (Npcf) for the PCF 1126, a service-based interface (Nudm) for the UDM 1127, a service-based interface (Naf) for the AF 1128, a service-based interface (Nnrf) for the NRF 1125, and a service-based interface (Nausf) for the AUSF 1122.

The system 1100 may include the following reference points, including a reference point (N1) between the UE 1101 and the AMF 1121, a reference point (N2) between the RAN node 1111 and the AMF 1121, a reference point (N3) between the RAN node 1111 and the UPF 1102, a reference point (N4) between the SMF 1124 and the UPF 1102, and a reference point (N6) between the UPF 1102 and the data network 1103. There may be many more reference points and/or service-based interfaces between the NF services in the NFs; however, these interfaces and reference points have been omitted herein for clarity. For example, the system 1100 may further include an N5 reference point between the PCF 1126 and the AF 1128, an N7 reference point between the PCF 1126 and the SMF 1124, an N11 reference point between the AMF 1121 and the SMF 1124, etc. In some embodiments, the 5GC 1120 may include an Nx interface that is an inter-CN interface between an MME (e.g., the MME 1021 in FIG. 10) and the AMF 1121 in order to enable interworking between the 5GC 1120 and the CN 1020.

Although not shown in FIG. 11, the system 1100 may include more than one RAN nodes 1111, and an Xn interface is defined between two or more RAN nodes 1111 (e.g., gNBs and the like) connected to the 5GC 1120, between a RAN node 1111 (e.g., gNB) connected to the 5GC 1120 and an eNB (e.g., a RAN node 1011 of FIG. 10), and/or between two eNBs connected to the 5GC 1120.

In some implementations, the Xn interface may include an Xn user plane (Xn-U) interface and an Xn control plane (Xn-C) interface. The Xn-U interface may provide non-guaranteed delivery of user plane PDUs and support/provide data forwarding and flow control functionality. The Xn-C interface may provide management and error handling functionality, functionality to manage the Xn-C interface, and mobility support for the UE 1101 in a connected mode (e.g., CM-CONNECTED). The mobility support of the UE 1101 may include functionality to manage the UE mobility for connected mode between one or more RAN nodes 1111. The mobility support may also include context transfer from an old (source) serving RAN node 1111 to new (target) serving RAN node 1111, and control of user plane tunnels between the old (source) serving RAN node 1111 and the new (target) serving RAN node 1111.

An Xn-U protocol stack of the Xn-U interface may include a transport network layer built on Internet Protocol (IP) transport layer, and a GTP-U layer on top of a UDP and/or IP layer(s) to carry user plane PDUs. An Xn-C protocol stack of the Xn-C interface may include an application layer signaling protocol (referred to as Xn Application Protocol (Xn-AP)) and a transport network layer that is built on an SCTP layer. The SCTP layer may be on top of an IP layer. The SCTP layer provides the guaranteed delivery of application layer messages. In the transport IP layer, point-to-point transmission is used to deliver the signaling PDUs. In other implementations, the Xn-U protocol stack and/or the Xn-C protocol stack may be same as or similar to the user plane and/or control plane protocol stack(s) shown and described herein.

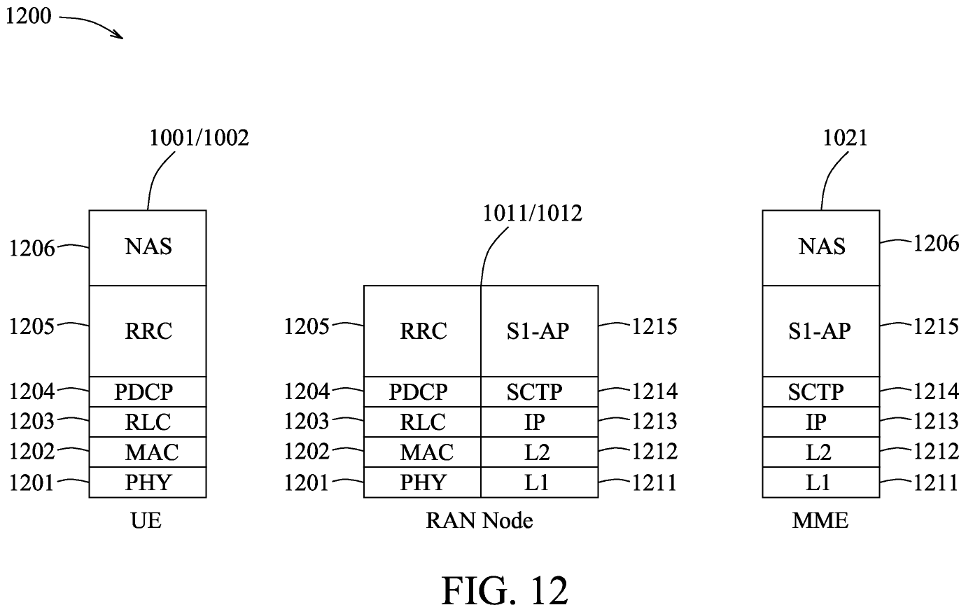

FIG. 12 illustrates an example of a control plane protocol stack according to some embodiments of this disclosure. In the example of FIG. 12, a control plane 1200 is shown as a communications protocol stack between the UE 1001 (or alternatively, the UE 1002), the RAN node 1011 (or alternatively, the RAN node 1012), and the MME 1021.

The PHY layer 1201 may transmit or receive information used by the MAC layer 1202 over one or more air interfaces. The PHY layer 1201 may further perform link adaptation or adaptive modulation and coding (AMC), power control, cell search (e.g., for initial synchronization and handover purposes), and other measurements used by higher layers, such as the RRC layer 1205. The PHY layer 1201 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1202 may perform mapping between logical channels and transport channels, multiplexing of MAC service data units (SDUs) from one or more logical channels onto transport blocks (TB) to be delivered to the PHY layer 1201 via transport channels, de-multiplexing MAC SDUs to one or more logical channels from transport blocks (TB) delivered from the PHY layer 1201 via transport channels, multiplexing MAC SDUs onto TBs, scheduling information reporting, error correction through hybrid automatic repeat request (HARQ), and logical channel prioritization.

The RLC layer 1203 may operate in a plurality of modes of operation, including Transparent Mode (TM), Unacknowledged Mode (UM) and Acknowledged Mode (AM). The RLC layer 1203 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1203 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1204 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1205 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE 1001 or 1002 and the E-UTRAN (e.g., RRC connection paging, RRC connection establishment, RRC connection modification, and RRC connection release), establishment, configuration, maintenance and release of point-to-point radio bearers, security functions including key management, inter radio access technology (RAT) mobility, and measurement configuration for UE measurement reporting. Said MIBs and SIBs may include one or more information elements (IEs), which may each comprise individual data fields or data structures.

The UE 1001 and the RAN node 1011 of FIG. 10 may utilize a Uu interface (e.g., an LTE-Uu interface) to exchange control plane data via a protocol stack including the PHY layer 1201, the MAC layer 1202, the RLC layer 1203, the PDCP layer 1204 and the RRC layer 1205.

The non-access stratum (NAS) protocols 1206 form the highest stratum of the control plane between the UE 1001 or 1002 and the MME 1021. The NAS protocols 1206 support the mobility of the UE 1001 or 1002 and the session management procedures to establish and maintain IP connectivity between the UE 1001 or 1002 and the P-GW 1023 (see FIG. 10).

The S1 Application Protocol (S1-AP) layer 1215 may support the functions of the S1 interface, and include Elementary Procedures (EPs). An EP is a unit of interaction between the RAN node 1011 or 1012 and the CN 1020 (see FIG. 10). The S1-AP layer 1215 provides services that may include two groups, i.e., UE-associated services and non UE-associated services. These services perform functions including, but not limited to, E-UTRAN Radio Access Bearer (E-RAB) management, UE capability indication, mobility, NAS signaling transport, RAN Information Management (RIM), and configuration transfer.

A Stream Control Transmission Protocol (SCTP) layer 1214 may ensure reliable delivery of signaling messages between the RAN node 1011 or 1012 and the MME 1021 based, in part, on the IP protocol supported by the IP layer 1213. An L2 layer 1212 and an L1 layer 1211 may refer to communication links (e.g., wired or wireless) used by the RAN node 1011 or 1012 and the MME 1021 to exchange information.

The RAN node 1011 and the MME 1021 may utilize an S1-MME interface to exchange control plane data via a protocol stack including the L1 layer 1211, the L2 layer 1212, the IP layer 1213, the SCTP layer 1214, and the S1-AP layer 1215.

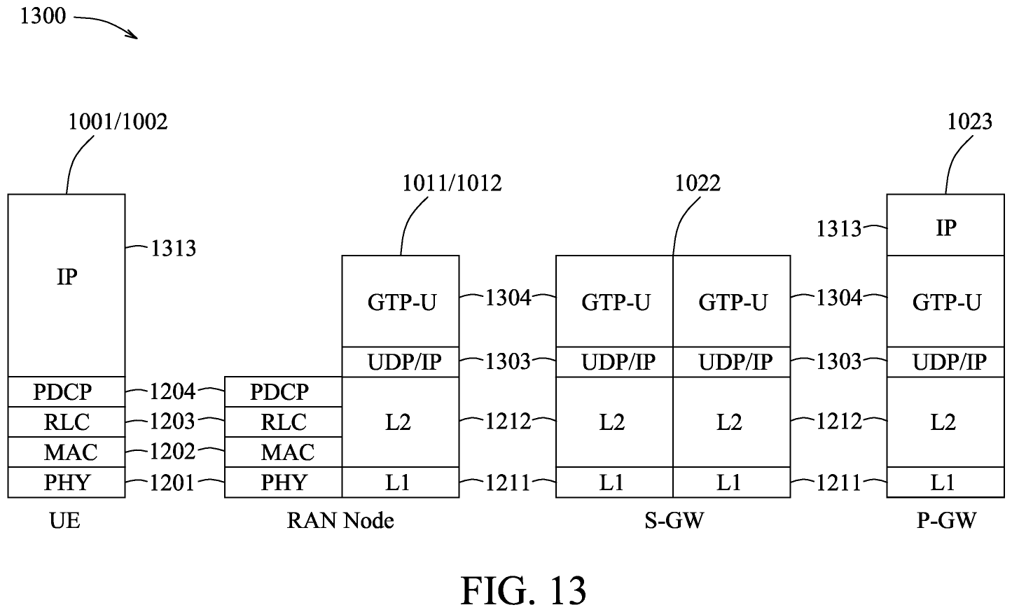

FIG. 13 illustrates an example of a user plane protocol stack according to some embodiments of this disclosure. In this example, a user plane 1300 is shown as a communications protocol stack between the UE 1001 (or alternatively, the UE 1002), the RAN node 1011 (or alternatively, the RAN node 1012), the S-GW 1022, and the P-GW 1023. The user plane 1300 may utilize at least some of the same protocol layers as the control plane 1200 of FIG. 12. For example, the UE 1001 or 1002 and the RAN node 1011 or 1012 may utilize a Uu interface (e.g., an LTE-Uu interface) to exchange user plane data via a protocol stack also including a PHY layer 1201, a MAC layer 1202, an RLC layer 1203 and a PDCP layer 1204 (see FIG. 12). The protocol stack for the UE 1001 or 1002 may further include an IP layer 1313.

A General Packet Radio Service (GPRS) Tunneling Protocol for the user plane (GTP-U) layer 1304 may be used for carrying user data within the GPRS core network and between the radio access network and the core network. The user data transported can be packets in any of IPv4, IPv6, or PPP formats. A UDP and IP security (UDP/IP) layer 1303 may provide checksums for data integrity, port numbers for addressing different functions at the source and destination, and encryption and authentication on the selected data flows. The RAN node 1011 or 1012 and the S-GW 1022 may utilize an S1-U interface to exchange user plane data via a protocol stack including the L1 layer 1211, the L2layer 1212, the UDP/IP layer 1303, and the GTP-U layer 1304. The S-GW 1022 and the P-GW 1023 may utilize an S5/S8a interface to exchange user plane data via a protocol stack including the L1 layer 1211, the L2 layer 1212, the UDP/IP layer 1303, and the GTP-U layer 1304. The protocol stack for the P-GW 1023 may further include the IP layer 1313. As discussed above with respect to FIG. 12, NAS protocols support the mobility of the UE 1001 or 1002 and the session management procedures to establish and maintain IP connectivity between the UE 1001 or 1002 and the P-GW 1023.

### EXAMPLES

The following examples pertain to specific technology embodiments and point out specific features, elements, or actions that can be used or otherwise combined in achieving such embodiments.

Example 1 is an apparatus operable for unlicensed narrowband transmission to support Internet-of-Things (IoT) service. The apparatus comprises a baseband circuitry that includes one or more processors to select a transmission channel within an unlicensed narrow band for downlink transmission of a discovery reference signal (DRS), and for channel hopping, to select, according to the DRS, a communication channel within the unlicensed narrow band for downlink data and uplink data. The DRS includes a primary synchronization signal (PSS), a secondary synchronization signal (SSS) and physical broadcast channel (PBCH) content.

Example 2 is the apparatus of Example 1, wherein the one or more processors of the baseband circuitry are to predetermine at least one anchor channel as the transmission channel for the downlink transmission of the DRS.

Example 3 is the apparatus of Example 2, wherein the at least one anchor channel is only for the downlink transmission of the DRS.

Example 4 is the apparatus of Example 2, wherein the one or more processors of the baseband circuitry are to select the at least one anchor channel as the communication channel. Example 5 is the apparatus of Example 4, wherein the one or more processors of the baseband circuitry are to divide a frame in each of the at least one anchor channel into a downlink subframe and an uplink subframe while satisfying

$$\frac{{T}_{D L}}{{N}_{anchor} {D}_{well}} = 10 \%$$

where T_{DL} indicates a time duration of the downlink subframe, N_{anchor} indicates a number of the at least one anchor channel, and D_{well} indicates a dwell time.

Example 6 is the apparatus of Example 4 further comprising a radio frequency (RF) circuitry to use the at least one anchor channel as one of a physical random access channel (PRACH), an Msg3 physical uplink shared channel (PUSCH) and a physical uplink control channel (PUCCH) for the uplink data.

Example 7 is the apparatus of Example 2, wherein the one or more processors of the baseband circuitry are to predetermine a number of the at least one anchor channel, where the number of the at least one anchor channel depends on a region where the apparatus is to be used.

Example 8 is the apparatus of Example 2, wherein the one or more processors of the baseband circuitry are to predetermine a number of the at least one anchor channel, where the number of the at least one anchor channel is identical for all regions.

Example 9 is the apparatus of Example 2, wherein the one or more processors of the baseband circuitry are to predetermine the at least one anchor channel according to a cell identifier (cell ID) associated with a radio access network (RAN) node.

Example 10 is the apparatus of Example, wherein the one or more processors of the baseband circuitry are to predetermine a channel within the unlicensed narrow band having the smallest or largest index as the at least one anchor channel.

Example 11 is the apparatus of Example 2, wherein the one or more processors of the baseband circuitry are to divide a frame in each of the at least one anchor channel into multiple orthogonal subframes, and to randomly select one of the orthogonal subframes for the DRS so as to reduce probability of collision of the DRS's.

Example 12 is the apparatus of Example 2, wherein the one or more processors of the baseband circuitry are to determine, according to a cell ID associated with a radio access network (RAN) node, a subframe in the at least one anchor channel for starting the DRS.

Example 13 is the apparatus of Example 1, wherein the one or more processors of the baseband circuitry are to select, from a plurality of channels within the unlicensed narrow band, the transmission channel for the DRS, and to select the transmission channel as the communication channel.

Example 14 is the apparatus of Example 13, further comprising a radio frequency (RF) circuitry to use the plurality of channels each as one of a narrowband physical downlink control channel (NPDCCH), a narrowband physical downlink shared channel (NPDSCH) and a physical uplink shared channel (PUSCH) for broadcasting and unicasting data.

Example 15 is the apparatus of Example 1, wherein the baseband circuitry is to control the RF circuitry to transmit the DRS periodically.

Example 16 is the apparatus of Example 15, wherein, in a case that an interval between two consecutive transmissions of the DRS is an integer number of times of the dwell time, the DRS will not be transmitted on all channels and will only be transmitted on the channel having the frame that overlaps in time with the transmission of the DRS.

Example 17 is the apparatus of Example 1, wherein the one or more processors of the baseband circuitry are further to detect, from among a plurality of channels within the unlicensed narrow band, a free channel that is unoccupied. The apparatus further comprises radio frequency (RF) circuitry to provide a presence signal at beginning of a frame in the free channel to notify a user equipment of the free channel, so that the user equipment is to transmit and receive data through the free channel upon receipt of the presence signal.

Example 18 is the apparatus of Example 1, wherein the one or more processors of the baseband circuitry are to determine, based on medium-utilization limitation, a dwell time during which the communication channel is to transmit and receive data.

Example 19 is a method for unlicensed narrowband transmission to support Internet-of-Things (IoT) service. The method is to be implemented by a baseband circuitry and comprises: selecting a transmission channel within an unlicensed narrow band for downlink transmission of a discovery reference signal (DRS) that includes a primary synchronization signal (PSS), a secondary synchronization signal (SSS) and physical broadcast channel (PBCH) content; and for channel hopping, selecting, according to the DRS, a communication channel within the unlicensed narrow band for downlink data and uplink data.

Example 20 is the method of Example 19, wherein selecting the transmission channel within the unlicensed narrow band for the downlink transmission of the DRS includes predetermining at least one anchor channel as the transmission channel for the downlink transmission of the DRS.

Example 21 is the method of Example 20, wherein the at least one anchor channel is only for the downlink transmission of the DRS.

Example 22 is the method of Example 20, wherein selecting the communication channel within the unlicensed narrow band for downlink data and uplink data includes selecting the at least one anchor channel as the communication channel.

Example 23 is the method of Example 22, further comprising: dividing a frame in each of the at least one anchor channel into a downlink subframe and an uplink subframe while satisfying

$$\frac{{T}_{D L}}{{N}_{anchor} {D}_{well}} = 10 \%$$

where T_{DL} indicates a time duration of the downlink subframe, N_{anchor} indicates a number of the at least one anchor channel, and D_{well} indicates a dwell time.

Example 24 is the method of Example 22 that is to be implemented further by a radio frequency (RF) circuitry, and that further comprises: using, by the RF circuitry, the at least one anchor channel as one of a physical random access channel (PRACH), an Msg3 physical uplink shared channel (PUSCH) and a physical uplink control channel (PUCCH) for the uplink data.

Example 25 is the method of Example 20, wherein predetermining the at least one anchor channel includes predetermining a number of the at least one anchor channel, where the number of the at least one anchor channel depends on a region where the baseband circuitry is to be used.

Example 26 is the method of Example 20, wherein predetermining the at least one anchor channel includes predetermining a number of the at least one anchor channel, where the number of the at least one anchor channel is identical for all regions.

Example 27 is the method of Example 20, wherein predetermining the at least one anchor channel includes predetermining the at least one anchor channel according to a cell identifier (cell ID) associated with a radio access network node.

Example 28 is the method of Example 20, further comprising: dividing a frame in each of the at least one anchor channel into multiple orthogonal subframes; and randomly selecting one of the orthogonal subframes for the DRS so as to reduce probability of collision of the DRS's.

Example 29 is the method of Example 20, further comprising: determining, according to a cell ID associated with a radio access network node, a subframe in the at least one anchor channel for starting the DRS.

Example 30 is the method of Example 19, wherein selecting the transmission channel within the unlicensed narrow band for the downlink transmission of the DRS includes selecting, from a plurality of channels within the unlicensed narrow band, the transmission channel for the DRS; wherein selecting the communication channel within the unlicensed narrow band for downlink data and uplink data includes selecting the transmission channel as the communication channel.

Example 31 is the method of Example 30, further comprising: using, by radio frequency (RF) circuitry, the plurality of channels each as one of a narrowband physical downlink control channel (NPDCCH), a narrowband physical downlink shared channel (NPDSCH) and a physical uplink shared channel (PUSCH) for broadcasting and unicasting data.

Example 32 is the method of Example 19, further comprising: controlling a radio frequency (RF) circuitry to transmit the DRS periodically.

Example 33 is the method of Example 32, wherein, in a case that an interval between two consecutive transmissions of the DRS is an integer number of times of the dwell time, the DRS will not be transmitted on all channels and will only be transmitted on the channel having the frame that overlaps in time with the transmission of the DRS.

Example 34 is the method of Example 19 that is to be implemented further by a radio frequency (RF) circuitry, and that further comprises: detecting, by the baseband circuitry, from among a plurality of channels within the unlicensed narrow band, a free channel that is unoccupied; and providing, by the RF circuitry, a presence signal at beginning of a frame in the free channel to notify a user equipment of the free channel, so that the user equipment is to transmit and receive data through the free channel upon receipt of the presence signal.

Example 35 is the method of Example 19, further comprising: determining, based on medium-utilization limitation, a dwell time during which the communication channel is to transmit and receive data.

Example 36 is a tangible, non-transitory, computer-readable storage medium comprising instructions that, when executed by a processor, direct the processor to perform the method according to any one of Examples 19 to 35.

While the present techniques have been described with respect to a limited number of embodiments, those skilled in the art can appreciate numerous modifications and variations therefrom. It is intended that the appended claims cover all such modifications and variations as fall within the true spirit and scope of the present techniques.

In the foregoing specification, a detailed description has been given with reference to specific embodiments. It can, however, be evident that various modifications and changes may be made thereto without departing from the broader spirit and scope of the present techniques as set forth in the appended claims. The specification and drawings are, accordingly, to be regarded in an illustrative sense rather than a restrictive sense. Furthermore, the foregoing use of the term “embodiment” and other language does not necessarily refer to the same embodiment or the same example, but may refer to different and distinct embodiments, as well as potentially the same embodiment.

1. An apparatus operable for unlicensed narrowband transmission to support Internet-of-Things (IoT) service, the apparatus comprising a baseband circuitry that includes: a radio frequency (RF) interface; and
one or more processors to:
select a transmission channel within an unlicensed narrow band for downlink transmission of a discovery reference signal (DRS) that includes a primary synchronization signal (PSS), a secondary synchronization signal (SSS) and physical broadcast channel (PBCH) content; and
for channel hopping, select, according to the DRS, a communication channel within the unlicensed narrow band for downlink data and upink data.

2. The apparatus as claimed in claim 1, wherein the one or more processors of the baseband circuitry are to predetermine at least one anchor channel as the transmission channel for the downlink transmission of the DRS.

3. The apparatus as claimed in claim 2, wherein the at least one anchor channel is only for the downlink transmission of the DRS.

4. The apparatus as claimed in claim 2, wherein the one or more processors of the baseband circuitry are to select the at least one anchor channel as the communication channel.

5. The apparatus as claimed in claim 4, wherein the one or more processors of the baseband circuitry are to divide a frame in each of the at least one anchor channel into a downlink subframe and an uplink subframe while satisfying:
$$\frac{{T}_{D L}}{{N}_{anchor} {D}_{well}} = 10 \%$$
where T_{DL} indicates a time duration of the downlink subframe, N_{anchor} indicates a number of the at least one anchor channel, and D_{well} indicates a dwell time.

6. The apparatus as claimed in claim 4, further comprising a radio frequency (RF) circuitry to use the at least one anchor channel as one of a physical random access channel (PRACH), an Msg3 physical uplink shared channel (PUSCH) and a physical uplink control channel (PUCCH) for the upink data.

7. The apparatus as claimed in claim 2, wherein the one or more processors of the baseband circuitry are to predetermine a number of the at least one anchor channel, where the number of the at least one anchor channel depends on a region where the apparatus is to be used.

8. The apparatus as claimed in claim 2, wherein the one or more processors of the baseband circuitry are to predetermine a number of the at least one anchor channel, where the number of the at least one anchor channel is identical for all regions.

9. The apparatus as claimed in claim 2, wherein the one or more processors of the baseband circuitry are to predetermine the at least one anchor channel according to a cell identifier (cell ID) associated with a radio access network (RAN) node.

10. The apparatus as claimed in claim 2, wherein the one or more processors of the baseband circuitry are to divide a frame in each of the at least one anchor channel into multiple orthogonal subframes, and to randomly select one of the orthogonal subframes for the DRS so as to reduce probability of collision of the DRS's.

11. The apparatus as claimed in claim 2, wherein the one or more processors of the baseband circuitry are to determine, according to a cell identifier (cell ID) associated with a radio access network (RAN) node, a subframe in the at least one anchor channel for starting the DRS.

12. The apparatus as claimed in any of claim 1, wherein the one or more processors of the baseband circuitry are to select, from a plurality of channels within the unlicensed narrow band, the transmission channel for the DRS, and to select the transmission channel as the communication channel.

13. The apparatus as claimed in claim 12, further comprising a radio frequency (RF) circuitry to use the plurality of channels each as one of a narrowband physical downlink control channel (NPDCCH), a narrowband physical downlink shared channel (NPDSCH) and a physical uplink shared channel (PUSCH) for broadcasting and unicasting data.

14. The apparatus as claimed in any of claim 1, wherein the one or more processors of the baseband circuitry are further to detect, from among a plurality of channels within the unlicensed narrow band, a free channel that is unoccupied,
wherein the apparatus further comprises radio frequency (RF) circuitry to provide a presence signal at beginning of a frame in the free channel to notify a user equipment of the free channel, so that the user equipment is to transmit and receive data through the free channel upon receipt of the presence signal.

15. The apparatus as claimed in any of claim 1, wherein the one or more processors of the baseband circuitry are to determine, based on medium-utilization limitation, a dwell time during which the communication channel is to transmit and receive data.

16. A method for unlicensed narrowband transmission to support Internet-of-Things (IoT) service, the method to be implemented by a baseband circuitry and comprising:
selecting a transmission channel within an unlicensed narrow band for downlink transmission of a discovery reference signal (DRS) that includes a primary synchronization signal (PSS), a secondary synchronization signal (SSS) and physical broadcast channel (PBCH) content;
for channel hopping, selecting, according to the DRS, a communication channel within the unlicensed narrow band for downlink data and upink data.

17. The method as claimed in claim 16, wherein selecting the transmission channel within the unlicensed narrow band for the downlink transmission of the DRS includes predetermining at least one anchor channel as the transmission channel for the downlink transmission of the DRS.

18. The method as claimed in claim 17, wherein the at least one anchor channel is only for the downlink transmission of the DRS.

19. The method as claimed in claim 17, wherein selecting the communication channel within the unlicensed narrow band for downlink data and uplink data includes selecting the at least one anchor channel as the communication channel.

20. The method as claimed in claim 19, further comprising:
dividing a frame in each of the at least one anchor channel into a downlink subframe and an uplink subframe while satisfying
$$\frac{{T}_{D L}}{{N}_{anchor} {D}_{well}} = 10 \%$$
where T_{DL} indicates a time duration of the downlink subframe, N_{anchor} indicates a number of the at least one anchor channel, and D_{well} indicates a dwell time.

21. The method as claimed in claim 19, to be implemented further by a radio frequency (RF) circuitry, and further comprising:
using, by the RF circuitry, the at least one anchor channel as one of a physical random access channel (PRACH), an Msg3 physical uplink shared channel (PUSCH) and a physical uplink control channel (PUCCH) for the uplink data.

22. The method as claimed in claim 17, wherein predetermining the at least one anchor channel includes predetermining a number of the at least one anchor channel, where the number of the at least one anchor channel depends on a region where the baseband circuitry is to be used.

23. The method as claimed in claim 17, wherein predetermining the at least one anchor channel includes predetermining a number of the at least one anchor channel, where the number of the at least one anchor channel is identical for all regions.

24. The method as claimed in claim 17, wherein predetermining the at least one anchor channel includes predetermining the at least one anchor channel according to a cell identifier (cell ID) associated with a radio access network node.

25. The method as claimed in claim 17, further comprising:
dividing a frame in each of the at least one anchor channel into multiple orthogonal subframes; and
randomly selecting one of the orthogonal subframes for the DRS so as to reduce probability of collision of the DRS's.

26. The method as claimed in claim 17, further comprising:
determining, according to a cell identifier (cell ID) associated with a radio access network node, a subframe in the at least one anchor channel for starting the DRS.

27. The method as claimed in claim 16, wherein:
selecting the transmission channel within the unlicensed narrow band for the downlink transmission of the DRS includes selecting, from a plurality of channels within the unlicensed narrow band, the transmission channel for the DRS; and
selecting the communication channel within the unlicensed narrow band for downlink data and uplink data includes selecting the transmission channel as the communication channel.

28. The method as claimed in claim 27, to be implemented further by a radio frequency (RF) circuitry, and further comprising:
using, by the radio frequency (RF) circuitry, the plurality of channels each as one of a narrowband physical downlink control channel (NPDCCH), a narrowband physical downlink shared channel (NPDSCH) and a physical uplink shared channel (PUSCH) for broadcasting and unicasting data.

29. The method as claimed in claim 16, to be implemented further by a radio frequency (RF) circuitry, and further comprising:
detecting, by the baseband circuitry, from among a plurality of channels within the unlicensed narrow band, a free channel that is unoccupied; and
providing, by the RF circuitry, a presence signal at beginning of a frame in the free channel to notify a user equipment of the free channel, so that the user equipment is to transmit and receive data through the free channel upon receipt of the presence signal.

30. The method as claimed in claim 16, further comprising:
determining, based on medium-utilization limitation, a dwell time during which the communication channel is to transmit and receive data.

31. (canceled)
